(19) United States
(12) Patent Application Publication
(10) Pub. No.: US 2020/0135212 A1
(43) Pub. Date: Apr. 30, 2020

(54) SPEECH RECOGNITION METHOD AND APPARATUS IN ENVIRONMENT INCLUDING PLURALITY OF APPARATUSES

(71) Applicant: SAMSUNG ELECTRONICS CO., LTD., Suwon-si (KR)

(72) Inventors: Keunseok CHO, Suwon-si (KR); Jaeyoung ROH, Suwon-si (KR); Jiwon HYUNG, Suwon-si (KR); Donghan JANG, Suwon-si (KR); Jaewon LEE, Suwon-si (KR)

(21) Appl. No.: 16/662,387

(22) Filed: Oct. 24, 2019

(30) Foreign Application Priority Data
Oct. 24, 2018 (KR) 10-2018-0127696
Sep. 6, 2019 (KR) 10-2019-0110772

(51) Int. Cl. G10L 17/22; G10L 17/06; G10L 17/00

(52) U.S. Cl. CPC G10L 17/22; G10L 17/005; G10L 17/06

(57) ABSTRACT

Provided are an artificial intelligence (AI) system that utilizes a machine learning algorithm such as deep learning, etc. and an application of the AI system. A speech recognition method, performed by a speech recognition apparatus, of performing speech recognition in a space in which a plurality of speech recognition apparatuses are present includes extracting a speech signal of a speaker from an input audio signal; obtaining a first speaker recognition score indicating a similarity between the speech signal and a speech signal of a registration speaker; and outputting a speech recognition result with respect to the speech signal based on a second speaker recognition score obtained from another speech recognition apparatus among the plurality of speech recognition apparatuses and the first speaker recognition score.

### CROSS-REFERENCE TO RELATED APPLICATIONS

This application is based on and claims priority under 35 U.S.C. § 119 to Korean Patent Application No. 10-2018-0127696, filed on Oct. 24, 2018, in the Korean Intellectual Property Office, and to Korean Patent Application No. 10-2019-0110772, filed on Sep. 6, 2019, the Korean Intellectual Property Office, the disclosures of which are incorporated by reference herein in their entireties.

### BACKGROUND

### 1. Field

The disclosure relates to a speech recognition method and apparatus, and for example to, a method, performed by one speech recognition apparatus selected in an environment including a plurality of speech recognition apparatuses, of recognizing and outputting speech.

### 2. Description of Related Art

As electronic apparatuses that perform various functions in combination have been developed, electronic apparatuses equipped with a speech recognition function have been released to improve operability. The speech recognition function may easily control an apparatus by recognizing a speech of a user without a separate button operation or contact to a touch module.

According to the speech recognition function, for example, a portable terminal such as a smart phone and a home appliance such as a TV, a refrigerator, etc. may perform a call function or write a text message without pressing a separate button, and may easily set various functions such as directions, Internet search, alarm setting, etc.

Also, an artificial intelligence (AI) system may refer, for example, to a computer system with human level intelligence. Unlike an existing rule-based smart system, the AI system is a system that trains itself autonomously, makes decisions, and becomes increasingly smarter. The more the AI system is used, the more the recognition rate of the AI system may improve and the AI system may more accurately understand a user preference, and thus, an existing rule-based smart system is being gradually replaced by a deep learning based AI system.

AI technology refers to machine learning (deep learning) and element technologies that utilize the machine learning.

Machine learning may refer, for example, to an algorithm technology that classifies/learns the features of input data autonomously. Element technology may refer, for example, to a technology that utilizes a machine learning algorithm such as deep learning and may include technical fields such as linguistic understanding, visual comprehension, reasoning/prediction, knowledge representation, and motion control.

AI technology is applied to various fields as follows. Linguistic understanding may refer, for example, to a technology to identify and apply/process human language/characters and includes natural language processing, machine translation, dialogue systems, query response, speech recognition/synthesis, and the like. Reasoning prediction may refer, for example, to a technology to acquire and logically infer and predict information and includes knowledge/probability based reasoning, optimization prediction, preference based planning, recommendation, and the like. Knowledge representation may refer, for example, to a technology to automate human experience information into knowledge data and includes knowledge building (data generation/classification), knowledge management (data utilization), and the like.

### SUMMARY

According to an embodiment of the disclosure, a speech recognition apparatus closest to a user (among a plurality of speech recognition apparatuses) is correctly selected in a space in which a plurality of speech recognition apparatuses are present, and thus the selected speech recognition apparatus provides a service that satisfies needs of the user.

Additional aspects will be set forth in part in the description which follows and, in part, will be apparent from the description.

According to an example embodiment of the disclosure, a speech recognition method, performed by a speech recognition apparatus, of performing speech recognition in a space in which a plurality of speech recognition apparatuses are present includes extracting a speech signal of a speaker from an input audio signal; obtaining a first speaker recognition score indicating a similarity between the speech signal and a speech signal of a registration speaker; and outputting a speech recognition result with respect to the speech signal based on a second speaker recognition score obtained from another speech recognition apparatus among the plurality of speech recognition apparatuses and the first speaker recognition score.

According to an example embodiment of the disclosure, a speech recognition apparatus among a plurality of speech recognition apparatuses located in a same space includes a receiver comprising receiving circuitry configured to receive an input audio signal; a processor configured to control the speech recognition apparatus to: extract a speech signal of a speaker from the input audio signal and obtain a first speaker recognition score indicating a similarity between the speech signal and a speech signal of a registration speaker; and an outputter comprising output circuitry configured to output a speech recognition result with respect to the speech signal, wherein the processor is further configured to control the outputter to output the speech recognition result with respect to the speech signal based on a second speaker recognition score obtained from another speech recognition apparatus among the plurality of speech recognition apparatuses and the first speaker recognition score.

According to an example embodiment of the disclosure, a speech recognition method, performed by a device connected to a plurality of speech recognition apparatuses located in a same space, of performing speech recognition includes obtaining a first speaker recognition score indicating a similarity between a speech signal received by a first speech recognition apparatus and a speech signal of a registration speaker; obtaining a second speaker recognition score indicating a similarity between a speech signal received by a second speech recognition apparatus and the speech signal of the registration speaker; determining an apparatus closer to a speaker among the first speech recognition apparatus and the second speech recognition apparatus based on the first speaker recognition score and the second speaker recognition score; and based on the apparatus closer to the speaker being determined as the first speech recognition apparatus, outputting a speech recognition result with respect to a first speech signal to the first speech recognition apparatus.

According to an example embodiment of the disclosure, a device connected to a plurality of speech recognition apparatuses located in a same space includes a communicator comprising communication circuitry configured to receive a speech signal from each of a first speech recognition apparatus and a second speech recognition apparatus and a processor configured to control the device to: obtain a first speaker recognition score indicating a similarity between a speech signal received by the first speech recognition apparatus and a speech signal of a registration speaker, obtain a second speaker recognition score indicating a similarity between a speech signal received by the second speech recognition apparatus and the speech signal of the registration speaker, and determine an apparatus closer to a speaker among the first speech recognition apparatus and the second speech recognition apparatus based on the first speaker recognition score and the second speaker recognition score, wherein, based on the apparatus closer to the speaker being determined as the first speech recognition apparatus, the processor is further configured to control the device to output a speech recognition result with respect to a first speech signal to the first speech recognition apparatus.

According to an example embodiment of the disclosure, a speech recognition system including a plurality of speech recognition apparatuses located in a same space and a device connected to the plurality of speech recognition apparatuses is provided, wherein among the plurality of speech recognition apparatuses, a first speech recognition apparatus is configured to receive a first speech signal with respect to an utterance of a speaker and to transmit the first speech signal to the device, wherein among the plurality of speech recognition apparatuses, a second speech recognition apparatus is configured to receive a second speech signal with respect to the same utterance of the speaker and to transmit the second speech signal to the device, and wherein the device is configured to obtain a first speaker recognition score indicating a similarity between the first speech signal and a speech signal of a registration speaker, to obtain a second speaker recognition score indicating a similarity between the second speech signal and the speech signal of the registration speaker, to determine an apparatus closer to the speaker among the first speech recognition apparatus and the second speech recognition apparatus based on the first speaker recognition score and the second speaker recognition score, and based on the apparatus closer to the speaker being determined as the first speech recognition apparatus, to output a speech recognition result with respect to a first speech signal to the first speech recognition apparatus.

### BRIEF DESCRIPTION OF THE DRAWINGS

The above and other aspects, features, and advantages of certain embodiments of the disclosure will be more apparent from the following detailed description, taken in conjunction with the accompanying drawings, in which:

FIG. 1 is a flowchart of a method of selecting one speech recognition apparatus in a space in which a plurality of speech recognition apparatuses are present, and performing speech recognition, according to the related art;

FIG. 2A is a diagram illustrating an example speech recognition system according to an embodiment of the disclosure;

FIG. 2B is a diagram illustrating an example speech recognition system according to an embodiment of the disclosure;

FIG. 2C is a diagram illustrating an example speech recognition system according to an embodiment of the disclosure;

FIG. 3A is a block diagram illustrating an example speech recognition apparatus according to an embodiment of the disclosure;

FIG. 3B is a block diagram illustrating an example speech recognition apparatus according to an embodiment of the disclosure;

FIG. 3C is a block diagram illustrating an example speech recognition apparatus according to an embodiment of the disclosure;

FIG. 4 is a flowchart illustrating an example speech recognition method according to an embodiment of the embodiment;

FIG. 5 is a block diagram illustrating an example processor according to an embodiment of the disclosure;

FIG. 6 is a flowchart illustrating an example speech recognition method according to an embodiment of the disclosure;

FIG. 7 is a flowchart an example speech recognition method according to an embodiment of the disclosure;

FIG. 8 is a diagram illustrating an example in which speech recognition apparatuses output a speech recognition result, according to an embodiment of the disclosure;

FIG. 9A is a diagram illustrating an example in which a speech recognition system outputs a speech recognition result, according to an embodiment of the disclosure;

FIG. 9B is a diagram illustrating an example in which a speech recognition system outputs a speech recognition result, according to an embodiment of the disclosure;

FIG. 10A is a diagram illustrating an example in which a speech recognition system outputs a speech recognition result, according to an embodiment of the disclosure; and

FIG. 10B is a diagram illustrating an example in which a speech recognition system outputs a speech recognition result, according to an embodiment of the disclosure.

### DETAILED DESCRIPTION

Hereinafter, various example embodiments of the disclosure will be described in greater detail with reference to the accompanying drawings. However, the disclosure may be embodied in many different forms and is not limited to the example embodiments of the disclosure described herein. In order to clearly describe the disclosure, portions that are not relevant to the description may be omitted, and like reference numerals in the drawings denote like elements.

It will be understood that when region is referred to as being “connected to” another region, the region may be directly connected to the other region or electrically connected thereto with an intervening region therebetween. It will be further understood that the terms “comprises” and/or “comprising” used herein specify the presence of stated features or components, but do not preclude the presence or addition of one or more other features or components.

The expression “according to an embodiment” used in the disclosure does not necessarily indicate the same embodiment of the disclosure.

The aforementioned embodiments of the disclosure may be described in terms of functional block components and various processing steps. Some or all of such functional blocks may be realized by any number of hardware and/or software components configured to perform the specified functions. For example, functional blocks according to the disclosure may be realized by one or more microprocessors or by circuit components for a predetermined function. In addition, for example, functional blocks according to the disclosure may be implemented with any programming or scripting language. The functional blocks may be implemented in algorithms that are executed on one or more processors. Furthermore, the disclosure described herein could employ any number of techniques according to the related art for electronics configuration, signal processing and/or control, data processing and the like. The words “module” and “configuration” are used broadly and are not limited to mechanical or physical embodiments of the disclosure.

Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device.

Throughout the disclosure, the expression “at least one of a, b or c” indicates only a, only b, only c, both a and b, both a and c, both b and c, all of a, b, and c, or variations thereof.

Hereinafter, the disclosure will be described in greater detail with reference to the attached drawings.

Because a speech recognition technology has been recently mounted on various apparatuses, an apparatus closest to a user is selected from various apparatuses, and thus the selected speech recognition apparatus may be required to perform speech recognition. Speech recognition apparatuses of the related art use a method of selecting the closest apparatus based on a signal to noise ratio (SNR) of a received speech signal.

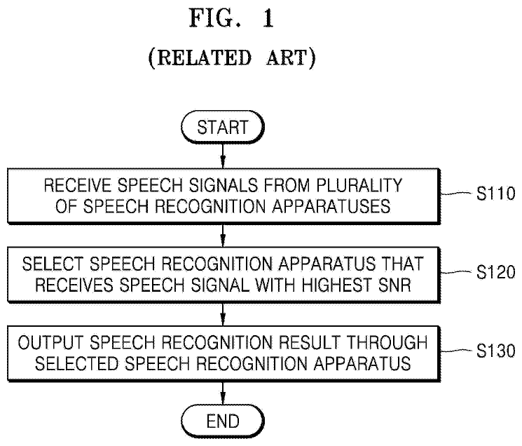

FIG. 1 is a flowchart illustrating a method performed by a speech recognition system including a plurality of speech recognition apparatuses of selecting one speech recognition apparatus and performing speech recognition according to the related art. The speech recognition system of the related art may select the speech recognition apparatus based on the SNR representing a ratio of an actual speech to noise of a surrounding environment.

Specifically, the speech recognition system of the related art may receive speech signals from the plurality of speech recognition apparatuses (S110). The speech recognition system may determine the SNR of each speech signal by analyzing the received speech signals. The speech recognition system may receive an audio signal including the speech signal and the noise, and determine an energy ratio of the speech signal and the noise. The speech recognition system may select the speech recognition apparatus that receives a speech signal having the highest SNR from the speech recognition apparatuses (S120). That is, the speech recognition system may select the speech recognition apparatus having the greatest intensity of the received speech signal. The speech recognition system may output a speech recognition result through the selected speech recognition apparatus (S130).

In a quiet environment, the SNR decreases as a distance between a speaker and the speech recognition apparatus increases. Therefore, according to the speech recognition method according to the related art illustrated in FIG. 1, the apparatus closest to the speaker may be relatively accurately selected from the plurality of speech recognition apparatuses located in the quiet environment. However, in a noisy general environment, the method of selecting the apparatus closest to the speaker based on the SNR according to the related art has a limitation in that its performance remarkably degrades.

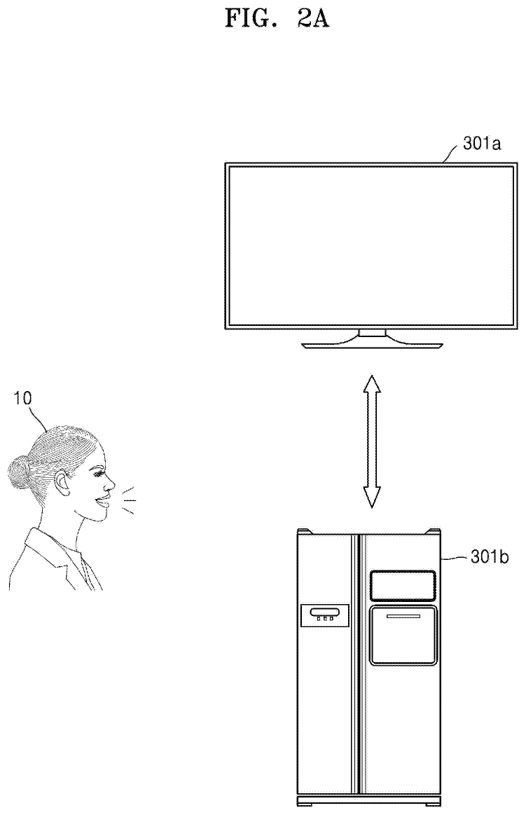

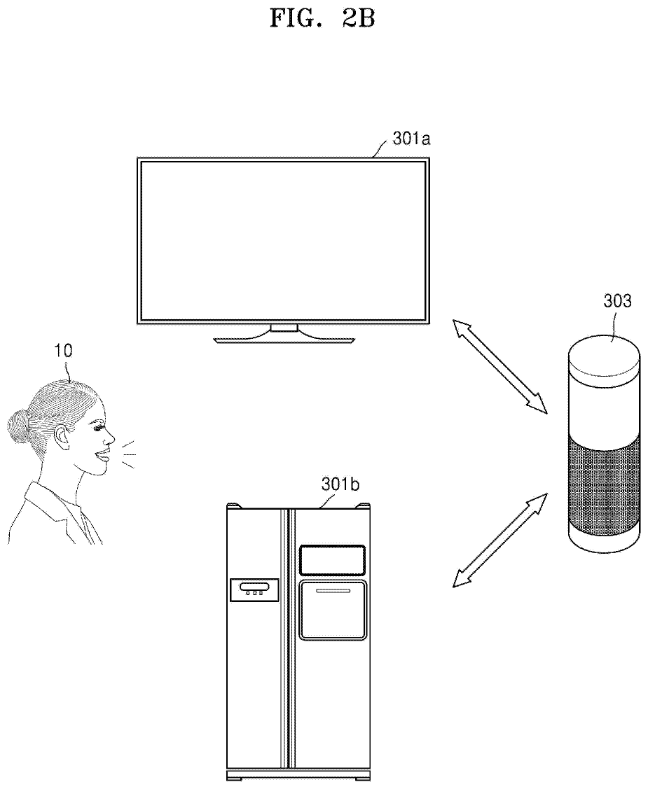

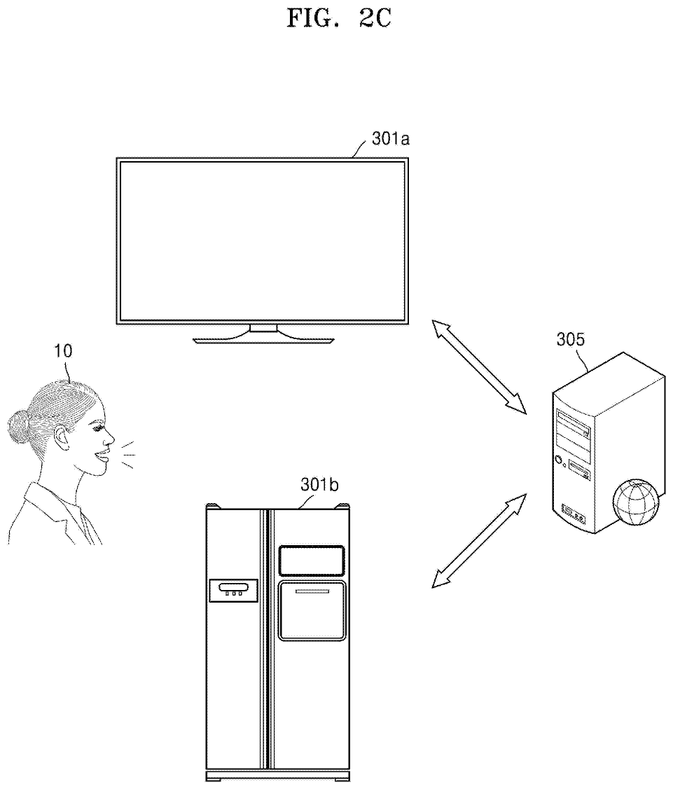

According to an embodiment of the disclosure to address the problem of the speech recognition system for performing the speech recognition method illustrated in FIG. 1, a speech recognition system for performing speech recognition based on speaker recognition may be provided. FIG. 2A is a diagram illustrating an example speech recognition system according to an embodiment of the disclosure. FIG. 2B is a diagram illustrating an example speech recognition system according to an embodiment of the disclosure.

FIG. 2C is a diagram illustrating an example speech recognition system according to an embodiment of the disclosure.

As shown in FIG. 2A, the speech recognition system according to an embodiment of the disclosure may include a plurality of speech recognition apparatuses 301a and 301b. The first speech recognition apparatus 301a and the second speech recognition apparatus 301b may be collectively referred to as a speech recognition apparatus 301.

For example, the speech recognition apparatus 301 may be a home appliance such as, for example, and without limitation, a TV, a refrigerator, a washing machine, etc., a smartphone, a PC, a wearable device, a personal digital assistant (PDA), a media player, a micro server, a global positioning system (GPS) apparatus, an e-book terminal, a digital broadcasting terminal, a navigation, a kiosk, an MP3 player, a digital camera, another mobile or non-mobile computing apparatus, or the like, but is not limited thereto.

The speech recognition apparatus 301 according to an embodiment of the disclosure may activate a session, receive an audio signal including a speech signal uttered by a speaker 10, and perform speech recognition on the speech signal. The speech recognition apparatus 301 may output a speech recognition result.

As illustrated in FIG. 2A, the first speech recognition apparatus 301a and the second speech recognition apparatus 301b may be connected by wire or wirelessly, and may share data.

Each of the first speech recognition apparatus 301a and the second speech recognition apparatus 301b according to an embodiment of the disclosure may obtain a speaker recognition score based on a received speech signal. The speaker recognition score may represent a similarity between the received speech signal and a speech signal of a previously registered registration speaker. The first speech recognition apparatus 301a and the second speech recognition apparatus 301b according to an embodiment of the disclosure may share the speaker recognition score obtained by each speech recognition apparatus.

When a distance between a speaker and a speech recognition apparatus is far, a low speaker recognition score is measured. Therefore, when a registration speaker utters in an environment including a plurality of speech apparatuses, a speaker recognition score obtained by a speech recognition apparatus closer to the speaker is higher than a speaker recognition score obtained by a speech recognition apparatus far away from the speaker. Because the speaker recognition score is obtained based on a feature of the speech signal, the aforementioned characteristic is present even in a very noisy environment. For example, even when the registration speaker utters in the very noisy environment, the speaker recognition score obtained by the speech recognition apparatus closer to the speaker may be higher than the speaker recognition score obtained by the speech recognition apparatus far away from the speaker. Therefore, in an actual very noisy environment, the method of selecting a proximity apparatus based on the speaker recognition score according to an embodiment of the disclosure may be more accurate than the method of selecting the proximity apparatus based on the SNR according to the related art.

For example, the first speech recognition apparatus 301a may determine the speech recognition apparatus to be closer to the speaker 10, based on a first speaker recognition score obtained by the first speech recognition apparatus 301a and a second speaker recognition score obtained by the second speech recognition apparatus 301b. When it is determined that the first speech recognition apparatus 301a is the closest speech recognition apparatus from the speaker 10, the first speech recognition apparatus 301a may output the speech recognition result.

In addition, as shown in FIG. 2B, the speech recognition system according to an embodiment of the disclosure may include the first speech recognition apparatus 301a, the second speech recognition apparatus 301b, and a device 303. The first speech recognition apparatus 301a, the second speech recognition apparatus 301b, and the device 303 may be connected by wire or wirelessly.

The device 303 may share data, resources, and services with the plurality of speech recognition apparatuses 301a and 301b or perform control of the speech recognition apparatus 301, file management, or monitor the entire network. For example, the device 303 may be a mobile or non-mobile computing device, a device configuring a home network by connecting a plurality of speech recognition apparatuses 300, an edge device that processes data in an edge of a network, or a cloudlet representing a small-scale cloud datacenter.

The speech recognition apparatus 301 may receive the audio signal including the speech signal uttered by the speaker 10 and transmit the input audio signal to the device 303. The speech recognition apparatus 301 may receive the audio signal including the speech signal uttered by the speaker 10 and transmit a speech signal detected from the input audio signal to the device 303. The speech recognition apparatus 301 may receive the audio signal including the speech signal uttered by the speaker 10 and transmit a feature of the speech signal detected from the input audio signal or the speaker recognition score to the device 303.

The device 303 may obtain the speaker recognition score based on the signal received from the speech recognition apparatus 301. The device 303 may compare a speech signal of the previously registered registration speaker with the speech signal received from the speech recognition apparatus 301, thereby obtaining the speaker recognition score indicating a similarity between the two speech signals.

The device 303 may determine the speech recognition apparatus closer to the speaker 10, based on the first speaker recognition score obtained by the first speech recognition apparatus 301a and the second speaker recognition score obtained by the second speech recognition apparatus 301b. When the device 303 determines that the first speech recognition apparatus 301a is the closest speech recognition apparatus from the speaker 10, the device 303 may transmit the speech recognition result to the first speech recognition apparatus 301a, or may control the first speech recognition apparatus 301a to output the speech recognition result. The speech recognition apparatus 301 may output the speech recognition result.

Although not shown in FIG. 2B, the device 303 may be connected to an external server to update information for speech recognition, or to update information about a change in the speaker recognition score according to a distance from the speaker 10 to the speech recognition apparatus 301. The device 303 may transmit a speech signal to the external server and receive a result of speech recognition performed by the external server from the external server. The device 303 may again retransmit the speech recognition result received from the external server to the speech recognition apparatus 301.

In addition, as illustrated in FIG. 2C, the speech recognition system according to an embodiment of the disclosure may include the speech recognition apparatus 301a, the second speech recognition apparatus 301b, and a speech recognition server 305. The speech recognition apparatus 301 and the speech recognition server 305 may be connected by wire or wirelessly.

The speech recognition server 305 according to an embodiment of the disclosure may share data with the speech recognition apparatus 301. The speech recognition apparatus 301 according to an embodiment of the disclosure may activate a session and receive an audio signal including a speech signal uttered by the speaker 10. The speech recognition apparatus 301 may transmit the input audio signal to the speech recognition server 305. The speech recognition apparatus 301 may transmit the speech signal detected from the input audio signal to the speech recognition server 305. The speech recognition apparatus 301 may transmit a feature or a speaker recognition score of the speech signal detected from the input audio signal to the speech recognition server 305.

The speech recognition server 305 may obtain the speaker recognition score based on the signal received from the speech recognition apparatus 301. The speech recognition server 305 may compare a speech signal of a previously registered registration speaker with the speech signal received from the speech recognition apparatus 301, thereby obtaining the speaker recognition score indicating a similarity between the two speech signals.

The speech recognition server 305 may determine a speech recognition apparatus closer to the speaker 10, based on a first speaker recognition score obtained by the first speech recognition apparatus 301a and a second speaker recognition score obtained by the second speech recognition apparatus 301b. When the device 303 determines that the first speech recognition apparatus 301a is the closest speech recognition apparatus from the speaker 10, the speech recognition server 305 may transmit the speech recognition result to the first speech recognition apparatus 301a, or may control the first speech recognition apparatus 301a to output the speech recognition result.

The speech recognition server 305 may perform speech recognition based on the signal received from the speech recognition apparatus 301. For example, the speech recognition server 305 may perform speech recognition on the speech signal detected from the audio signal input from the speech recognition apparatus 301. The speech recognition server 305 may transmit a speech recognition result to the speech recognition apparatus 301. The speech recognition apparatus 301 may output the speech recognition result.

As illustrated in FIGS. 2A, 2B, and 2C, in the speech recognition system according to an embodiment of the disclosure, when the registered speaker transfers a speech command, each of a plurality of speech recognition apparatuses may calculate the speaker recognition score with respect to the speech command. The speaker recognition score may be different according to a distance between the speaker and speech recognition apparatus, which may be used to select an apparatus closest to the speaker. In the speech recognition system according to an embodiment of the disclosure, the selected speech recognition apparatus may recognize a speech command of the speaker, perform an operation corresponding to a speech recognition result, thereby providing a service capable of satisfying a requirement (needs) of a user.

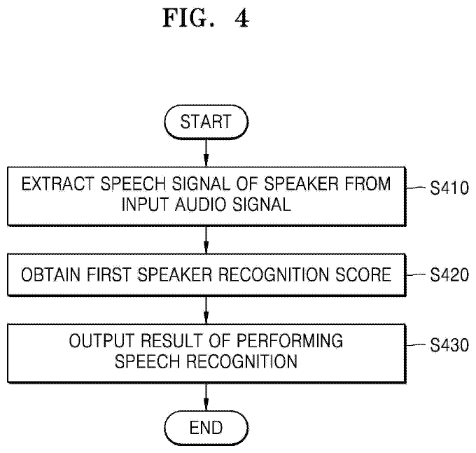

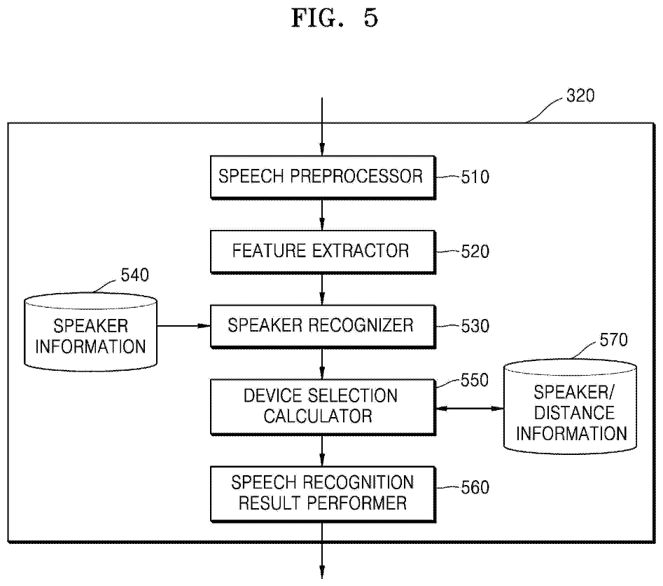

In addition, the speech recognition system according to an embodiment of the disclosure may be previously informed of information about locations of the speech recognition apparatuses. The speech recognition system may perform adaptive training on the speaker/distance information using at least one of the ‘location information of the speech recognition apparatuses’ or a ‘distance between the speaker and the speech recognition apparatus estimated based on the speaker recognition score’. The speaker/distance information may include previously stored information with respect to the change of the speaker recognition score according to the distance between the speaker and the speech recognition apparatus. For example, the speaker/distance information may include a basic table map, an updated table map, or a data recognition model that will be described in greater detail below with reference to FIGS. 4 and 5.

In addition, the speech recognition apparatus according to an embodiment of the disclosure may collect external environment information of the speech recognition apparatus by transmitting an impulse signal, and, based on the external environment information, perform adaptive training on a previously stored registration speaker model and/or speaker/distance information in relation to a speech signal of the registration speaker.

In addition, the speech recognition system according to an embodiment of the disclosure may utilize the previously stored speaker/distance information, such that another speech recognition apparatus may continuously perform speech recognition because a location of the speaker changes when the user moves while speaking.

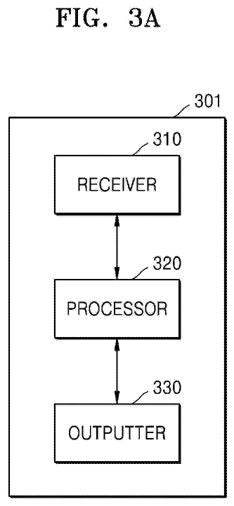

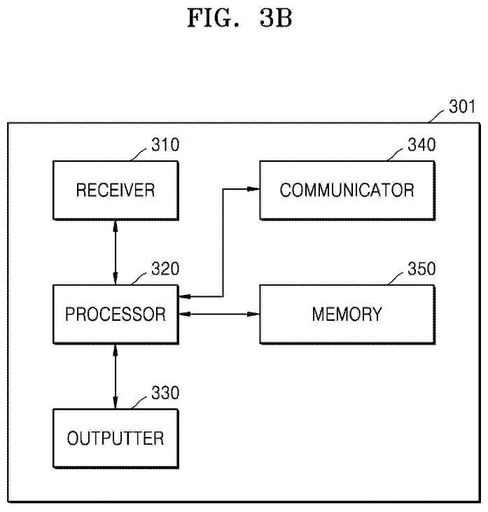

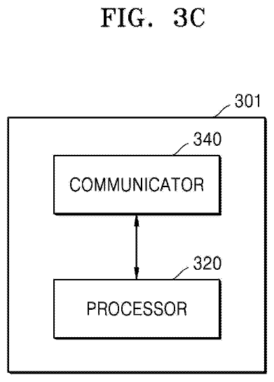

As shown in FIGS. 2A, 2B, and 2C, the speech recognition system according to an embodiment of the disclosure may include the plurality of speech recognition apparatuses, and may further include a device and/or a speech recognition server. Hereinafter, a speech recognition method performed by the “speech recognition apparatus” will be described for convenience of description. However, some or all of operations of the speech recognition apparatus described below may be performed by a device for connecting the speech recognition apparatus and the speech recognition server, and may be partially performed by the plurality of speech recognition apparatuses. FIG. 3A is a block diagram illustrating an example speech recognition apparatus according to an embodiment of the disclosure. FIG. 3B is a block diagram illustrating an example speech recognition apparatus according to an embodiment of the disclosure.

FIG. 3C is a block diagram illustrating an example speech recognition apparatus according to an embodiment of the disclosure.

As shown in FIG. 3A, the speech recognition apparatus 301 according to an embodiment of the disclosure may include a receiver (e.g., including receiver circuitry) 310, a processor (e.g., including processing circuitry) 320, and an outputter (e.g., including output circuitry) 330. However, the speech recognition apparatus 301 may be implemented by more components than all the components shown in FIG. 3A. For example, as illustrated in FIG. 3B, the speech recognition apparatus 301 according to an embodiment of the disclosure may further include a communicator (e.g., including communication circuitry) 340 and a memory 350.

Also, FIGS. 3A, 3B, and 3C illustrate that the speech recognition apparatus 301 includes one processor 320 for convenience, but the embodiment of the disclosure is not limited thereto, and the speech recognition apparatus 301 may include a plurality of processors. When the speech recognition apparatus 301 includes the plurality of processors, operations of the processor 320 described below may be separately performed by the plurality of processors.

The receiver 310 may include various receiver circuitry and receive an audio signal. For example, the receiver 310 may directly receive the audio signal by converting external sound into electrical acoustic data using a microphone. The receiver 310 may receive the audio signal transmitted from an external device. In FIGS. 3A and 3B, the receiver 310 is included in the speech recognition apparatus 301, but the receiver 310 according to another embodiment of the disclosure may be included in a separate apparatus and connected the speech recognition apparatus 301 by wire and/or wirelessly.

The receiver 310 may activate a session for receiving the audio signal based on the control of the processor 320. The session may indicate a time taken for the speech recognition apparatus 301 to start and end to receive the audio signal. Activating the session may refer, for example, to the speech recognition apparatus 301 starting to receive the audio signal. The receiver 310 may transmit the input audio signal input to the processor 320 while the session is maintained.

In addition, the receiver 310 may receive a user input for controlling the speech recognition apparatus 301. The receiver 310 may include various receiver circuitry, such as, for example, and without limitation, a user input device including a touch panel that receives a touch of a user, a button that receives a push operation of the user, a wheel that receives a rotation operation of the user, a key board, a dome switch, etc, but is not limited thereto. The receiver 310 may receive a user input received through a separate user input device without directly receiving the user input.

For example, the receiver 310 may receive a user input for storing a specific speaker as a registered speaker and a user input for activating the session.

The processor 320 may include various processing circuitry and extract a speech signal from the input audio signal input from the receiver 310 and perform speech recognition on the speech signal. In an embodiment of the disclosure, the processor 320 may extract frequency characteristics of the speech signal from the input audio signal and perform speech recognition using an acoustic model and a language model. The frequency characteristics may refer, for example, to a distribution of frequency components of an acoustic input, which is extracted by analyzing a frequency spectrum of the acoustic input. Thus, as shown in FIG. 3B, the speech recognition apparatus 301 may further include a memory 350 that stores the acoustic model and the language model.

In an embodiment of the disclosure, the processor 320 may obtain a speaker recognition score from the speech signal. The speaker recognition score may indicate a similarity between the received speech signal and a speech signal of a registration speaker.

The processor 320 may determine whether a speaker of the speech signal is a registered speaker based on the speaker recognition score obtained from the received speech signal. The processor 320 may determine whether to maintain the session based on a determination result.

For example, the processor 320 may set the session to be maintained for a previously determined session duration and to end after the session duration while activating the session. When the speaker of the speech signal detected from the input audio signal received while the session is activated is the registered speaker, the processor 320 may reset the session to be activated for a previously determined extension time and to end after the extension time.

The processor 320 may determine a speech recognition apparatus closest to the speaker among the plurality of speech recognition apparatuses based on the speaker recognition score. When it is determined that the speech recognition apparatus 301 is closest to the speaker, the processor 320 may control the outputter 330 to output a speech recognition result.

For example, the processor 320 according to an embodiment of the disclosure may obtain a first speaker recognition score from the speech signal received by the receiver 310. The processor 320 may control the outputter 330 to output the speech recognition result with respect to the speech signal received by the receiver 310 based on a second speaker recognition score obtained from another speech recognition apparatus among the plurality of speech recognition apparatuses and the first speaker recognition score.

The processor 320 according to an embodiment of the disclosure may determine an apparatus closer to the speaker among the speech recognition apparatus 301 and the other speech recognition apparatus based on a result of comparing the first speaker recognition score with the second speaker recognition score. The processor 320 may control the outputter 330 to output the speech recognition result when it is determined that the speech recognition apparatus 301 is the apparatus closer to the speaker.

The processor 320 according to an embodiment of the disclosure may determine the apparatus closer to the speaker among the speech recognition apparatus 301 and the other speech recognition apparatus, in further consideration of a location of the speech recognition apparatus 301, a location of the other speech recognition apparatus, and previously stored information with respect to a change in the speaker recognition score according to a distance between the speaker and the speech recognition apparatus 301.

The processor 320 according to an embodiment of the disclosure may determine the apparatus closer to the speaker among the speech recognition apparatus 301 and the other speech recognition apparatus, in consideration of speaker/distance information, the first speaker recognition score, and the second speaker recognition score. The speaker/distance information may include previously stored information with respect to the change of the speaker recognition score according to the distance between the speaker and the speech recognition apparatus 301. In this case, when the first speaker recognition score is equal to or greater than a threshold, the processor 320 according to an embodiment of the disclosure may update the speaker/distance information based on a result of determining the apparatus closer to the speaker.

The outputter 330 may include various output circuitry and output a result of speech recognition performed on the speech signal. The outputter 330 may notify the user of the result of speech recognition or transmit the result to an external device (e.g., a smart phone, a home appliance, a wearable device, an edge device, a server, etc.) For example, the outputter 330 may include a display capable of outputting an audio signal or a video signal.

The outputter 330 may perform an operation corresponding to the result of speech recognition. For example, the speech recognition apparatus 301 may determine a function of the speech recognition apparatus 301 corresponding to the result of speech recognition and output a screen performing the function through the outputter 330. The speech recognition apparatus 301 may transmit a keyword corresponding to the result of speech recognition to an external server, receive information related to the transmitted keyword from the server, and output the information on the screen through the outputter 330.

The communicator 340 of FIG. 3B may include various communication circuitry and communicate with an external device, an apparatus, or server through wired communication or wireless communication. The communicator 340 may receive an audio signal, a speech signal, a feature of the speech signal, a speaker recognition score, a speech recognition result, etc. from an external apparatus. The communicator 340 may transmit the audio signal, the speech signal, the feature of the speech signal, the speaker recognition score, or the speech recognition result to the external apparatus. The communicator 340 according to an embodiment of the disclosure may include various modules including various communication circuitry, such as, for example, and without limitation, a short range communication module, a wired communication module, a mobile communication module, a broadcast receiving module, etc.

The memory 350 of FIG. 3B may store an acoustic model for performing speech recognition, a language model, a registration speaker model with respect to a speech signal of a registered speaker for performing speaker recognition, a speech recognition history, speaker/distance information related to a relationship between a distance between a speaker and a speech recognition apparatus and the speaker recognition score, location information of speech recognition apparatuses, etc.

As illustrated in FIG. 3C, the speech recognition apparatus 301 according to an embodiment of the disclosure may include the communicator (e.g., including communication circuitry) 340 and the processor (e.g., including processing circuitry) 320. The block diagram shown in FIG. 3C may also be applied to the device 303 and speech recognition server 305 shown in FIGS. 2B and 2C. The communicator 340 and the processor 320 of FIG. 3C correspond to the communicator 340 and the processor 320 of FIGS. 3A and 3B, and thus redundant descriptions may not be repeated here.

The speech recognition apparatus 301 according to an embodiment of the disclosure may receive a speech signal from each of a first speech recognition apparatus and a second speech recognition apparatus through the communicator 340.

The speech recognition apparatus 301 may obtain a first speaker recognition score based on a first speech signal received from the first speech recognition apparatus. The first speaker recognition score may indicate a similarity between the first speech signal and a speech signal of the registration speaker. The speech recognition apparatus 301 may obtain a second speaker recognition score based on a second speech signal received from the second speech recognition apparatus. The second speaker recognition score may indicate a similarity between the second speech signal and the speech signal of the registration speaker.

The speech recognition apparatus 301 according to an embodiment of the disclosure may directly obtain the speaker recognition score from each of the first and second speech recognition apparatuses through the communicator 340.

The speech recognition apparatus 301 may determine an apparatus closer to the speaker among the first speech recognition apparatus and the second speech recognition apparatus based on the first speaker recognition score and the second speaker recognition score.

When the apparatus closer to the speaker is determined as the first speech recognition apparatus, the speech recognition apparatus 301 may control the communicator 340 to output a speech recognition result with respect to the first speech signal to the first speech recognition apparatus.

Hereinafter, an example operation method of the speech recognition apparatus 301 according to an embodiment of the disclosure will be described. Each operation of the method described below may be performed by each configuration of the speech recognition apparatus 301 described above. For convenience of description, only the case where the speech recognition apparatus 301 is a subject of an operation is described, but the following description may be applied to the case where a device for connecting a plurality of speech recognition apparatuses or a speech recognition server is the subject of the operation.

FIG. 4 is a flowchart illustrating an example speech recognition method according to an embodiment of the disclosure.

In operation S410, the speech recognition apparatus 301 according to an embodiment of the disclosure may extract a speech signal of a speaker from an input audio signal. The speech recognition apparatus 301 may be located in the same space as other speech recognition apparatuses. That a plurality of speech recognition apparatuses are located in the same space may refer, for example, to the plurality of speech recognition apparatuses being located within a range in which a speech signal generated by an utterance of a speaker may be generated.

In operation S420, the speech recognition apparatus 301 according to an embodiment of the embodiment may obtain a first speaker recognition score indicating a similarity between the speech signal and a speech signal of a registration speaker.

The registration speaker may be a main user of the speech recognition apparatus 301. For example, when the speech recognition apparatus 301 is a smart phone, an owner of the smart phone may be the registration speaker, and when the speech recognition apparatus 301 is a home appliance, family members living in a house where the home appliance is located may be registration speakers. The speech recognition apparatus 301 may register a speaker based on a user input or store a predetermined speaker as the registration speaker as a default value. The speech recognition apparatus 301 may store one speaker as the registration speaker and may store a plurality of speakers as the registration speakers.

In an embodiment of the disclosure, the speech recognition apparatus 301 may store a speech feature of a specific speaker as registration speaker information. For example, the speech recognition apparatus 300 may extract and store the registration speaker information from feature vectors extracted from a plurality of speech signals uttered by the specific speaker before a session is activated.

In an embodiment of the disclosure, the speech recognition apparatus 301 may calculate a speaker recognition score indicating a similarity between previously stored registration speaker information and newly generated speaker information. The speech recognition apparatus 301 may determine whether the speaker of the speech signal is a registered speaker based on a result of comparing the calculated speaker recognition score with a predetermined threshold.

The speech recognition apparatus 301 may obtain a candidate speaker recognition score indicating a similarity between the speech signal of the registration speaker and the speech signal received in operation S410. When there are a plurality of registration speakers, the speech recognition apparatus 301 may obtain a plurality of candidate speaker recognition scores indicating similarities between the speech signal extracted in operation S410 and a speech signal of each of the plurality of registration speakers. The speech recognition apparatus 301 may obtain the plurality of candidate speaker recognition scores with respect to the plurality of registration speakers by comparing the feature of the speech signal received in operation S410 with features of the speech signals of all registration speakers.

The speech recognition apparatus 301 may select a first registration speaker corresponding to the first candidate speaker recognition score having the highest value from among the plurality of candidate speaker recognition scores (speaker identification). The speech recognition apparatus 301 may determine the first candidate speaker recognition score as a first speaker recognition score when the first candidate speaker recognition score is greater than or equal to the threshold. When the first candidate speaker recognition score is less than the threshold, the speech recognition apparatus 301 may end a procedure without outputting a speech recognition result with respect to the speech signal received in operation S410. The speech recognition apparatus 301 may perform speech recognition only when the registration speaker utters (that is, only when the speaker recognition score is equal to or greater than the threshold) (speaker authentication).

The speech recognition apparatus 301 according to an embodiment of the disclosure may filter an utterance of another person who interrupts the utterance of the speaker through speaker recognition.

In addition, the speech recognition apparatus 301 according to an embodiment of the disclosure may obtain a second speaker recognition score obtained by a speech recognition apparatus other than the speech recognition apparatus 301 among the plurality of speech recognition apparatuses. The speech recognition apparatus 301 may obtain the second speaker recognition score from at least one of another speech recognition apparatus, a device connecting speech recognition apparatuses, a server, or an external memory. The second speaker recognition score may be a speaker recognition score obtained with respect to the same utterance as that of the speaker that is the basis of the speech signal extracted in operation S410. The second speaker recognition score may indicate a similarity between a speech signal received by another speech recognition apparatus and the speech signal of the registration speaker with respect to the same utterance.

In operation S430, the speech recognition apparatus 301 may output the speech recognition result with respect to the speech signal based on the second speaker recognition score and the first speaker recognition score.

The speech recognition apparatus 301 may determine an apparatus closer to the speaker among the speech recognition apparatus 301 and the other speech recognition apparatus based on a result of comparing the first speaker recognition score with the second speaker recognition score. When the speech recognition apparatus 301 is determined as the apparatus closer to the speaker, the speech recognition apparatus 301 may output the speech recognition result with respect to the speech signal received in operation S410.

For example, when the first speaker recognition score is greater than the second speaker recognition score, the speech recognition apparatus 301 may determine that the speech recognition apparatus 301 is closer to the speaker than the other speech recognition apparatus. When it is determined that the speech recognition apparatus 301 is the apparatus closest to the speaker, the speech recognition apparatus 301 may output the speech recognition result with respect to the speech signal received in operation S410.

In this example, in determining the apparatus closest to the speaker, the speech recognition apparatus 301 may further consider not only the speaker recognition score but also at least one of a location of the speech recognition apparatus 301, a location of the other speech recognition apparatus, or speaker/distance information. The speaker/distance information may include previously stored information with respect to a change in the speaker recognition score obtained by the speech recognition apparatus 301 as a distance between the speaker and the speech recognition apparatus 301 changes.

In determining the apparatus closest to the speaker, the speech recognition apparatus 301 may predict the distance between the speaker and the speech recognition apparatus 301 in consideration of at least one of the first speaker recognition score, the second speaker recognition score, or the speaker/distance information. The speech recognition apparatus 301 may determine the apparatus closer to the speaker among the speech recognition apparatus 301 and the other speech recognition apparatus based on the predicted distance. The speech recognition apparatus 301 may determine the apparatus closer to the speaker among the speech recognition apparatus 301 and the other speech recognition apparatus by comparing the predicted distance between the speaker and the speech recognition apparatus 301 and a predicted distance between the speaker and the other speech recognition apparatus.

According to an embodiment of the disclosure, the speech recognition system may include a basic table map of speaker recognition scores with respect to a distance between a speech recognition apparatus and a speaker having no label through an utterance of the speaker. At this time, because a distribution of the speaker recognition scores according to the distance may vary depending on the speaker, the basic table map may be updated based on the speaker recognition scores of an actual utterance of the speaker and the predicted distance.

For example, the basic table map of the speaker recognition scores with respect to the distance between the speech recognition apparatus 301 and the speaker may include information as shown, for example, in Table 1 below.

TABLE 1

| | distance (m) | | | | | |
|---|---|---|---|---|---|---|
| | 0.5 | 1 | 1.5 | 2 | 2.5 | 3 |
| speaker | 13.6268 | 11.3283 | 9.6495 | 7.9708 | 6.2920 | 4.6132 |
| recognition | | | | | | |
| score | | | | | | |

Table 1 above is an example of the speaker recognition scores with respect to an utterance of a registration speaker matching based on the distance between the speech recognition apparatus 301 and the registration speaker. The speech recognition apparatus 301 according to an embodiment of the disclosure may generate an extended table based on Table 1 such that intervals between distance values indicated by the table may be denser. In addition, the speech recognition apparatus 301 may include a table map reflecting speaker recognition scores that vary according to an external environment, based on information about the external environment.

In an environment where a plurality of speech recognition apparatuses are present, location information of each speech recognition apparatus may be shared with each other. Each speech recognition apparatus may obtain a speaker recognition score with respect to an utterance input to the speech recognition apparatus, and predict a distance between the speaker and the speech recognition apparatus based on locations of the speech recognition apparatuses, the speaker recognition score, and the basic table map. In addition, the speech recognition system according to an embodiment of the disclosure may additionally update the table map updated for each speaker, based on information stored in an account connected to speaker information.

The speech recognition apparatus 301 according to an embodiment of the disclosure may perform adaptive training on the speaker/distance information based on at least one of the location information of the speech recognition apparatuses, the obtained speaker recognition score, the distance predicted based on the speaker recognition score, or the information about the external environment.

For example, the speech recognition apparatus 301 may output an impulse signal to the outside of the speech recognition apparatus 301. The speech recognition apparatus 301 may output the impulse signal toward a space in which a plurality of speech recognition apparatuses including the speech recognition apparatus 301 are located. The speech recognition apparatus 301 may obtain the information about the external environment of the speech recognition apparatus 301 by analyzing an audio signal received in response to the impulse signal. The information about the external environment may include, for example, and without limitation, a time delay of the received signal, noise, etc. The speech recognition apparatus 301 may renew the previously stored speaker information or speaker/distance information in relation to the speech signal of the registration speaker, based on the information about the external environment.

The speech recognition apparatus 301 according to an embodiment of the disclosure may identify information about a space in which the speech recognition apparatus 301 is used using the impulse signal. For example, the impulse signal transmitted from the speech recognition apparatus 301 may be finally received by the speech recognition apparatus 301 after hitting a wall or an object in the space. Accordingly, the speech recognition apparatus 301 may identify an echo characteristic of sound in the space by analyzing the received audio signal in response to the impulse signal.

The speech recognition apparatus 301 according to an embodiment of the disclosure may adjust a threshold used in a speaker recognition operation, based on the audio signal received in response to the impulse signal. The speech recognition apparatus 301 may renew the speaker/distance information based on the adjusted threshold. For example, the speech recognition apparatus 301 may adjust a table value with respect to the speaker recognition score according to the distance between the speaker and the speech recognition apparatus 301 based on the adjusted threshold. The speech recognition apparatus 301 may change a reference value for determining the speaker recognition score according to the external environment.

For another example, when the first speaker recognition score is greater than or equal to the threshold, the speech recognition apparatus 301 may renew the speaker/distance information based on the first speaker recognition score and the predicted distance between the speaker and the speech recognition apparatus 301.

The speech recognition system according to an embodiment of the disclosure may include an artificial intelligence (AI) system utilizing a machine learning algorithm such as deep learning. For example, the speech recognition system according to an embodiment of the disclosure may use AI to recognize the speaker, perform speech recognition, and select the apparatus closest to the speaker.

Functions related to AI according to the disclosure operate through a processor and a memory. The processor may include one processor or a plurality of processors. In this case, the one processor or the plurality of processors may include, for example, and without limitation, a general purpose processor such as a CPU, an AP, a digital signal processor (DSP), a graphics dedicated processor such as a GPU, a vision processing unit (VPU), an AI dedicated processor such as an NPU, or the like. The one processor or the plurality of processors may control to process input data according to a predefined operating rule stored in the memory or an AI model. When the one processor or the plurality of processors is the AI dedicated processor, the AI dedicated processor may be designed with a hardware structure specialized for processing a specific AI model.

The predefined operating rule or the AI model may be generated through training. For example, generating through training may refer, for example, to a basic AI model being trained using a plurality of training data by a learning algorithm such that the predefined operating rule or the AI model set to perform a wanted characteristic (or purpose) is generated. Such training may be performed in a device itself in which AI is performed according to the disclosure, or may be performed through a separate server and/or system. Examples of the learning algorithm may include, for example, and without limitation, supervised learning, unsupervised learning, semi-supervised learning, reinforcement learning, or the like, but are not limited to the above examples.

The AI model may include a plurality of neural network layers. Each of the plurality of neural network layers may have a plurality of weight values, and perform a neural network operation through an operation result of a previous layer and an operation between the plurality of weights. The plurality of weights of the plurality of neural network layers may be optimized by a training result of the AI model. For example, the plurality of weights may be updated to reduce or minimize a loss value or a cost value obtained in the AI model during a training process. The AI network may include a deep neural network (DNN), such as, for example, and without limitation, a convolutional neural network (CNN), a deep neural network (DNN), a recurrent neural network (RNN), restricted Boltzmann machine (RBM), a deep belief network (DBN), a bidirectional recurrent deep neural network (BRDNN), a deep Q-network, etc, but is not limited to the above examples. FIG. 5 is a block diagram illustrating an example processor 320 according to an embodiment of the disclosure.

Some or all of blocks shown in FIG. 5 may be implemented in hardware and/or software configurations that perform specific functions. The functions performed by the blocks shown in FIG. 5 may be implemented by one or more microprocessors or by circuit configurations for the function and may include executable program elements. For example, some or all of the blocks shown in FIG. 5 may be software modules configured in various programming languages or script languages that are executed on the processor 320.

After a session is activated, a speech preprocessor (e.g., including processing circuitry and/or executable program elements) 510 may extract a speech signal corresponding to an utterance from an input audio signal when a speaker inputs the utterance targeted for speech recognition. The speech preprocessor 510 may transfer the extracted speech signal to a feature extractor 520.

A feature extractor (e.g., including processing circuitry and/or executable program elements) 520 may extract a speaker recognition feature vector robust to speaker recognition from the detected speech signal and extract a speech recognition feature vector robust to speech recognition from the speech signal.

A speaker recognizer (e.g., including processing circuitry and/or executable program elements) 530 may generate information about the speaker of the speech signal, using the speaker recognition feature vector, post information received in real time from a speech recognition decoder for performing speech recognition, a general background model, and total variability transformation information obtained by training based on big data. The speaker recognizer 530 may compare generated speaker information with information 540 of a previously registered speaker and calculate a speaker recognition score indicating a similarity between the speaker information and the registered speaker information 540. In an embodiment of the disclosure, the information 540 of a speech signal of the registered speaker may be previously stored.

The speaker recognizer (e.g., including processing circuitry and/or executable program elements) 530 may determine whether the speaker of the detected speech signal and the previously registered speaker are the same by comparing the speaker recognition score with a predetermined threshold. The speaker recognizer 530 may transfer a determination result to a device selection calculator 550.

The device selection calculator (e.g., including processing circuitry and/or executable program elements) 550 may receive speaker recognition scores of a plurality of speech recognition apparatuses and select a speech recognition apparatus closest to the speaker based on the speaker recognition scores. For example, the device selection calculator 550 may select a speech recognition apparatus having the relatively largest speaker recognition score as the speech recognition apparatus closest to the speaker.

The device selection calculator 550 may select the speech recognition apparatus closest to the speaker in further consideration of not only the speaker recognition score but also speaker/distance information 570. In determining the apparatus closest to the speaker, the device selection calculator 550 may predict a distance between each speech recognition apparatus and the speaker in consideration of speaker recognition scores obtained from the plurality of speech recognition apparatuses and the speaker/distance information 570. The device selection calculator 550 may select the speech recognition apparatus closest to the speaker based on the predicted distance between each speech recognition apparatus and the speaker.

In addition, the device selection calculator 550 may update the speaker/distance information 570 based on the predicted distance between each speech recognition apparatus and the speaker and the speaker recognition score. The speaker/distance information 570 may include a data recognition model used to determine the apparatus closest to the speaker.

For example, in determining the apparatus closest to the speaker, the device selection calculator 550 may use the data recognition model using obtained data as an input value. The data recognition model may be previously constructed based on a basic table map with respect to speaker recognition scores according to the distance between the speech recognition apparatus and the speaker. In addition, the device selection calculator 550 may use a result value output by the data recognition model to train the data recognition model.

For example, the device selection calculator 550 may train the data recognition model based on an utterance of an actual speaker. Because a distribution of speaker recognition scores according to distances may vary according to the speaker, the data recognition model may be trained based on actually obtained speaker recognition scores and prediction distances.

For another example, the device selection calculator 550 may train the data recognition model based on at least one of location information of speech recognition apparatuses or information about an external environment.

The device selection calculator 550 may predict the distance between each speech recognition apparatus and the speaker by applying the speaker recognition score obtained based on the speech signal input to each speech recognition apparatus to the data recognition model, and determine the apparatus closest to the speaker.

A speech recognition result performer (e.g., including processing circuitry and/or executable program elements) 560 may output a speech recognition result when the speech signal is uttered by the registered speaker and it is determined that the speech recognition apparatus 301 is the speech recognition apparatus closest to the speaker. The speech recognition result performer 560 may include a speech recognition decoder. The speech recognition decoder may perform speech recognition through an acoustic model and a language model using a speech recognition feature vector and generate the speech recognition result. The speech recognition decoder may transfer post information extracted through the acoustic model to the speaker recognizer 530 in real time.

Referring to FIG. 5, the speaker information 540 and the speaker/distance information 570 may be stored in the processor 320, but an embodiment of the disclosure is not limited thereto. The speaker information 540, the speaker/distance information 570, the acoustic model, the language model, the speech recognition result, the speaker recognition score, etc. may be stored in the memory 350 of the speech recognition apparatus 301, or may be stored in an external apparatus or an external server.

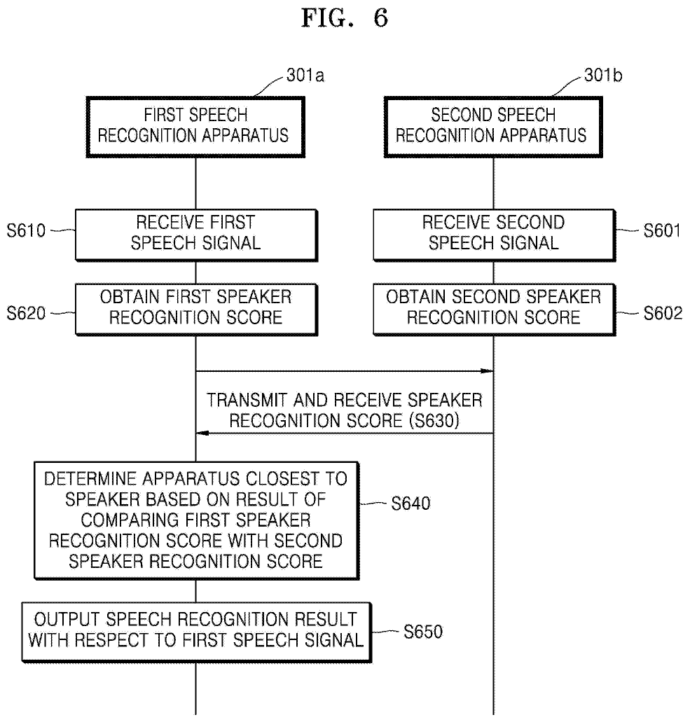

FIG. 6 is a flowchart illustrating an example method of operating a speech recognition system including a plurality of speech recognition apparatuses according to an embodiment of the disclosure. In FIG. 6, an example in which a speaker is closer to a first speech recognition apparatus 301a in a space including the first speech recognition apparatus 301a and a second speech recognition apparatus 301b is illustrated as an example but the embodiment of the disclosure is not limited thereto. The speech recognition system according to an embodiment of the disclosure may include three or more speech recognition apparatuses and determine a speech recognition apparatus closest to the speaker from among the speech recognition apparatuses through an application of FIG. 6.

When the speaker utters, the first speech recognition apparatus 301a and the second speech recognition apparatus 301b may receive speech signals corresponding to the corresponding utterance (S610 and S601). The first speech recognition apparatus 301a may obtain a first speaker recognition score indicating a degree of similarity between a first speech signal received in operation S610 and a speech signal of a registration speaker (S620).The second speech recognition apparatus 301b may obtain a second speaker recognition score indicating a degree of similarity between a second speech signal received in operation S601 and the speech signal of the registration speaker (S602).

The first speech recognition apparatus 301a and the second speech recognition apparatus 301b may share the obtained speaker recognition score (S630).

The first speech recognition apparatus 301a may determine the apparatus closest to the speaker based on a result of comparing the first speaker recognition score with the second speaker recognition score (S640). When the first speech recognition apparatus 301a is determined as the apparatus closest to the speaker, the first speech recognition apparatus 301a may output a speech recognition result with respect to the first speech signal (S650).

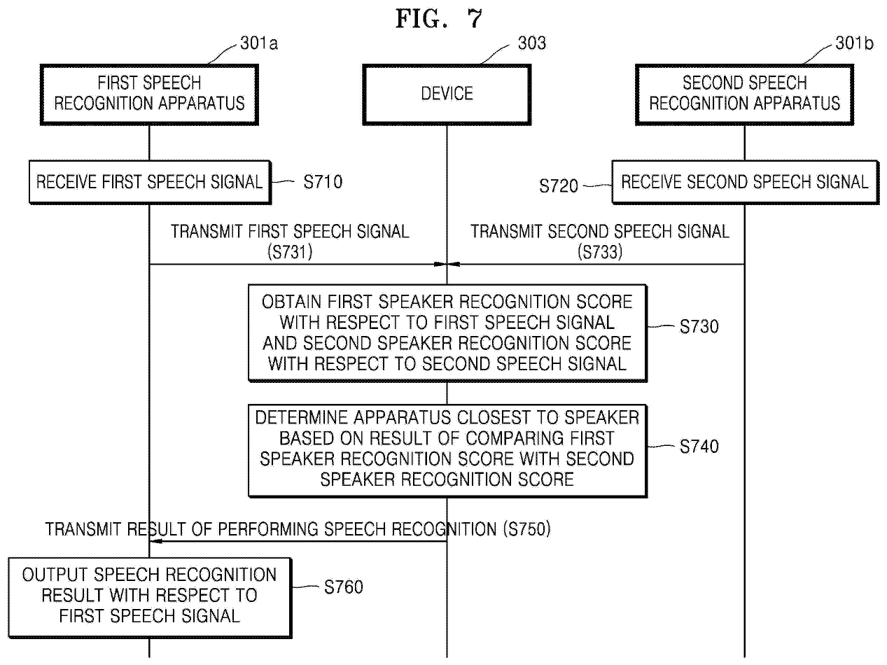

FIG. 7 is a flowchart illustrating an example method of operating a speech recognition system including a plurality of speech recognition apparatuses and a device for connecting the plurality of speech recognition apparatuses according to an embodiment of the disclosure. In FIG. 7, a case in which a speaker is closer to the first speech recognition apparatus 301a in a space including the first speech recognition apparatus 301a and the second speech recognition apparatus 301b is illustrated as an example but the embodiment of the disclosure is not limited thereto. The speech recognition system according to an embodiment of the disclosure may include three or more speech recognition apparatuses.

When a speaker utters, the first speech recognition apparatus 301a and the second speech recognition apparatus 301b may receive speech signals corresponding to the corresponding utterance (S710 and S720).The first speech recognition apparatus 301a may transmit the first speech signal received in S710 to the device 303 (S731). The second speech recognition apparatus 301b may transmit the second speech signal received in S720 to the device 303 (S733).

The device 303 may obtain a first speaker recognition score indicating a degree of similarity between the first speech signal and a speech signal of a registration speaker and a second speaker recognition score indicating a degree of similarity between the second speech signal and the speech signal of the registration speaker (S730).

The device 303 may determine an apparatus closest to the speaker based on a result of comparing the first speaker recognition score with the second speaker recognition score (S740). When the first speech recognition apparatus 301a is determined to be the apparatus closest to the speaker, the device 303 may transmit a speech recognition result to the first speech recognition apparatus 301a (S750). The first speech recognition apparatus 301a may output the speech recognition result (S760).

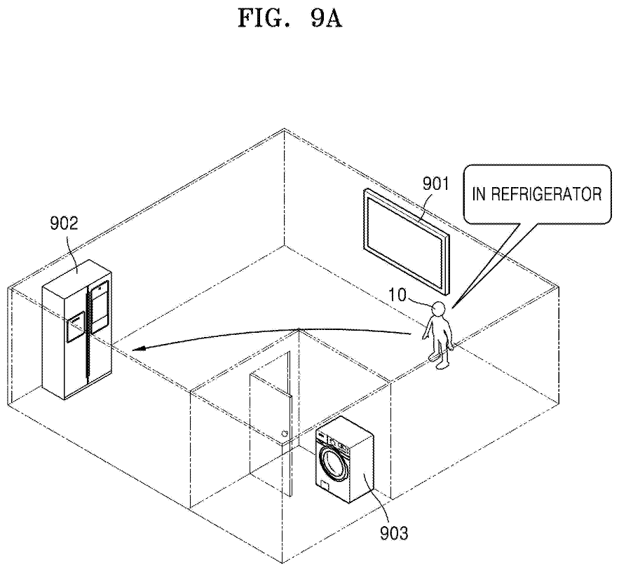

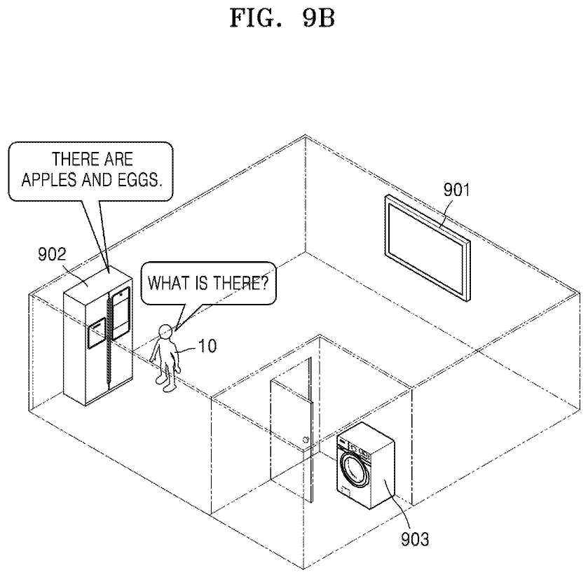

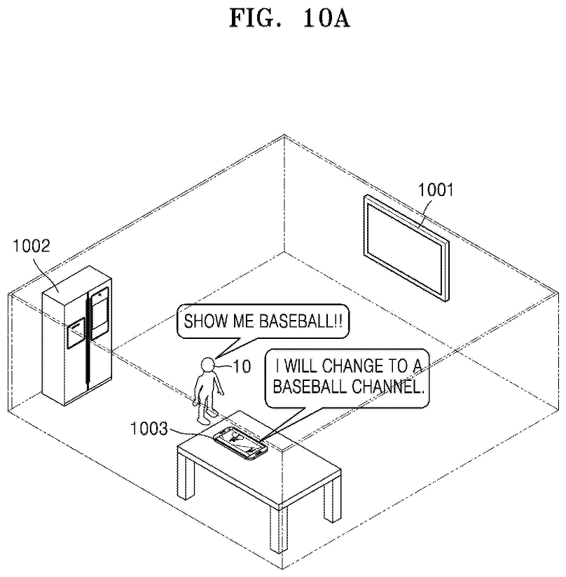

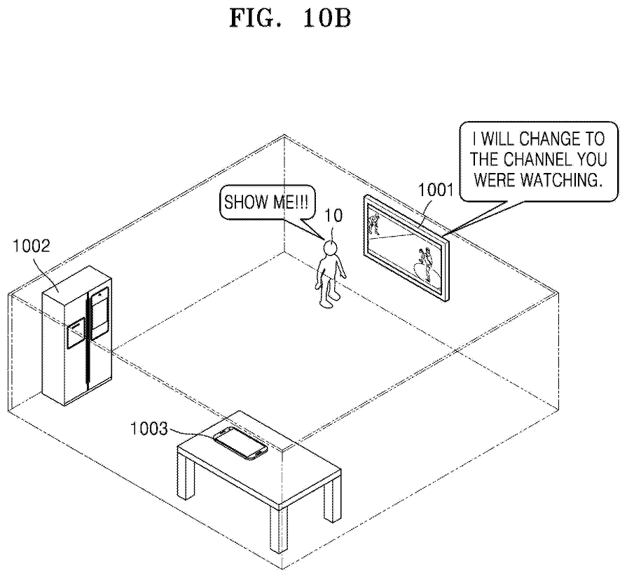

Hereinafter, an example in which the speech recognition apparatus 301 outputs the speech recognition result will be described with reference to FIGS. 9A to 10B. FIGS. 9A to 10B illustrate, for example, the cases where the speech recognition apparatus 301 is a TV, a refrigerator, a washing machine, or a smartphone equipped with a speech recognition function, and the speech recognition apparatus 301 recognizes a question or a request uttered by a speaker and outputs a response to the question or performs an operation corresponding to the request. However, an embodiment of the disclosure is not limited to the example shown in FIGS. 9A to 10B.

In addition, the speech recognition apparatus 301 illustrated in FIGS. 9A to 10B may independently recognize and output speech. The speech recognition apparatus 301 illustrated in FIGS. 9A to 10B may be connected to an external apparatus, transfer an input speech to the external apparatus, receive a speech recognition result from the external apparatus and output the speech recognition result. FIGS. 9A to 10B illustrate an example in which the speaker 10 is a registration speaker.

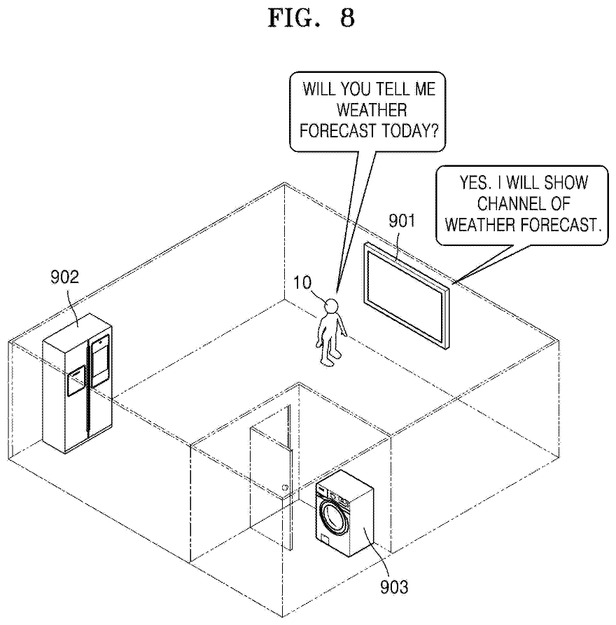

FIG. 8 is a diagram illustrating an example in which speech recognition apparatuses 901, 902, and 903 output a speech recognition result according to an embodiment of the disclosure.

As shown in FIG. 8, when the speaker 10 utters, “Will you tell me the weather forecast today?”, the plurality of speech recognition apparatuses 901, 902, and 903 may calculate and share speaker recognition scores and determine a speech recognition apparatus closest to the speaker 10. In the case of FIG. 8, the speech recognition apparatus 901 is located closest to the speaker 10. Thus, it may be determined that the speaker recognition score of the speech recognition apparatus 901 is the highest. Or, it may be determined that a predicted distance from the speaker 10 to the speech recognition apparatus 901 based on the speaker recognition score is the shortest. The speech recognition apparatus 901 may output the speech recognition result according to a determination result based on the speaker recognition score. As illustrated in FIG. 9, the speech recognition apparatus 901 may recognize a request of the speaker 10 and perform an operation of outputting a screen corresponding to a channel showing a weather forecast which is an operation corresponding to the request of the speaker 10.

FIG. 9A is a diagram illustrating an example in which a speech recognition system outputs a speech recognition result when the speaker 10 moves while uttering. FIG. 9B is a diagram illustrating an example in which a speech recognition system outputs a speech recognition result, according to an embodiment of the disclosure

As shown in FIG. 9A, the speaker 10 may be located closest to the speech recognition apparatus 901 while uttering “in the refrigerator . . . ” at the beginning of utterance. As shown in FIG. 9B, the speaker 10 may move toward the speech recognition apparatus 902 while continuing to utter “What is there?”.

The plurality of speech recognition apparatuses 901, 902, and 903 may calculate and share speaker recognition scores and determine a speech recognition apparatus closest to the speaker 10. In the case of FIG. 9B, the speech recognition apparatus 902 is located closest to the speaker 10 at the end of the utterance. Thus, the speech recognition apparatus 902 may recognize a question of the speaker 10 and output “There are apples and eggs.” which is a response to the question of the speaker 10.

As shown in FIGS. 9A and 9B, when the speaker 10 moves while uttering, the speech recognition system according to an embodiment of the disclosure may output the speech recognition result through the speech recognition apparatus closest to the speaker 10 at the end of the utterance. However, the embodiments of the disclosure are not limited thereto, and the speech recognition system may output the speech recognition result through the speech recognition apparatus closest to the speaker 10 at the beginning or middle of the utterance.

FIG. 10A is a diagram illustrating an example in which a speech recognition system comprising apparatuses 1001, 1002, and 1003 outputs a speech recognition result according to an embodiment of the disclosure. FIG. 10B is a diagram illustrating an example in which a speech recognition system comprising apparatuses 1001, 1002, and 1003 outputs a speech recognition result according to an embodiment of the disclosure.

As shown in FIG. 10A, when the speaker 10 utters “Show me baseball!!”, the plurality of speech recognition apparatuses 1001, 1002, and 1003 may calculate and share speaker recognition scores. The plurality of speech recognition apparatuses 1001, 1002, and 1003 may determine a speech recognition apparatus closest to the speaker 10. In the example of FIG. 10A, the speech recognition apparatus 1003 is located closest to the speaker 10. Thus, it may be determined that the speaker recognition score of the speech recognition apparatus 1003 is the highest. It may be determined that a predicted distance from the speaker 10 to the speech recognition apparatus 1003 based on the speaker recognition score is the shortest. The speech recognition apparatus 1003 may output the speech recognition result according to a determination result based on the speaker recognition score. As illustrated in FIG. 10A, the speech recognition apparatus 1003 may recognize a request of the speaker 10 and perform an operation of outputting a screen corresponding to a baseball relay channel which is an operation corresponding to the request of the speaker 10.

As shown in FIG. 10B, the speaker 10 may utter “Show me!!!” after moving from the speech recognition apparatus 1003 to the speech recognition apparatus 1001. The plurality of speech recognition apparatuses 1001, 1002, and 1003 may calculate and share the speaker recognition scores and determine the speech recognition apparatus closest to the speaker 10. In the example of FIG. 10B, because the speech recognition apparatus 1001 is located closest to the speaker 10, the speech recognition apparatus 1001 may recognize a request of the speaker 10 and perform an operation corresponding to the request of the speaker 10. The plurality of speech recognition apparatuses 1001, 1002, and 1003 may share a past operation history, a speech recognition history, etc. Therefore, the speech recognition apparatus 100 may output the screen corresponding to the baseball relay channel with reference to a history of the baseball relay channel output by the speech recognition apparatus 1003 together with an utterance “Show me” of the speaker 10.

Therefore, even when the speaker 10 utters while moving, the speech recognition system according to an embodiment of the disclosure may select an accurately close apparatus, thereby outputting a result of performing speech recognition corresponding to a users intention.

The embodiments of the disclosure may be implemented in a software program that includes instructions stored on a computer-readable storage medium.

The computer may include the image transmission apparatus and the image reception apparatus according to the embodiments of the disclosure, which are apparatuses capable of calling stored instructions from a storage medium and operating according to the embodiments of the disclosure in accordance with the called instructions.

The computer-readable storage medium may be provided in the form of a non-transitory storage medium. Here, the ‘non-transitory’ storage medium does not include a signal and is tangible, but does not distinguish whether data is stored semi-permanently or temporarily on the storage medium.

Further, the electronic apparatus or method according to the embodiments of the disclosure may be provided in a computer program product. The computer program product may be traded between a seller and a buyer as a product.

The computer program product may include a software program and a computer-readable storage medium having stored thereon the software program. For example, the computer program product may include a product (e.g., a downloadable application) in the form of a software program that is electronically distributed through a manufacturer of the electronic apparatus or an electronic marketplace (e.g. Google Play Store™ and App Store™). For electronic distribution, at least a part of the program may be stored on a storage medium or may be generated temporarily. In this case, the storage medium may be a storage medium of a server of the manufacturer, a server of the electronic market, or a relay temporarily storing the program.

The computer program product may include a storage medium of a server or a storage medium of a terminal (e.g., the image transmission apparatus or the image reception apparatus) in a system including the server and the terminal. Alternatively, when a third apparatus (e.g., a smart phone) in communication with the server or the terminal is present, the computer program product may include a storage medium of the third apparatus. The computer program product may include the program itself transmitted from the server to the terminal or the third apparatus, or transmitted from the third apparatus to the terminal.

In this case, one of the server, the terminal and the third apparatus may execute the computer program product to perform the method according to the embodiments of the disclosure. Two or more of the server, the terminal and the third apparatus may execute the computer program product to distribute the method according to the embodiments of the disclosure.

For example, the server (e.g., a cloud server or an AI server, etc.) may execute the computer program product stored in the server to control the terminal in communication with the server to perform the method according to the embodiments of the disclosure.

For another example, the third apparatus may execute the computer program product to control the terminal in communication with the third apparatus to perform the method according to the embodiment of the disclosure. For example, the third apparatus may remotely control the image transmission apparatus or the image reception apparatus to transmit or receive a packing image.

When the third apparatus executes the computer program product, the third apparatus may download the computer program product from the server and execute the downloaded computer program product. The third apparatus may execute the provided computer program product provided in a preloaded manner to perform the method according to the embodiments of the disclosure.

While the disclosure has been illustrated and described with reference to various example embodiments, it will be understood that the various example embodiments are intended to be illustrative, not limiting, and that various changes in form and detail may be made without departing from the true spirit and full scope of the disclosure.

What is claimed is:

1. A speech recognition method, performed by a speech recognition apparatus, for performing speech recognition in a space in which a plurality of speech recognition apparatuses are present,
the speech recognition method comprising:
extracting a speech signal of a speaker from an input audio signal;
obtaining a first speaker recognition score indicating a similarity between the speech signal and a speech signal of a registration speaker; and
outputting a speech recognition result with respect to the speech signal based on a second speaker recognition score obtained from an other speech recognition apparatus among the plurality of speech recognition apparatuses and based on the first speaker recognition score.

2. The speech recognition method of claim 1, further comprising:
obtaining the second speaker recognition score,
wherein the second speaker recognition score
indicates a similarity between a speech signal received by the other speech recognition apparatus and the speech signal of the registration speaker with respect to an utterance of the speaker.

3. The speech recognition method of claim 1, further comprising:
determining an apparatus closer to the speaker from among the speech recognition apparatus and the other speech recognition apparatus based on a result of comparing the first speaker recognition score with the second speaker recognition score,
wherein the outputting of the speech recognition result comprises:
outputting the speech recognition result with respect to the speech signal based on the apparatus closer to the speaker being determined as the speech recognition apparatus.

4. The speech recognition method of claim 1, wherein
the outputting of the speech recognition result comprises:
outputting the speech recognition result with respect to the speech signal based on the first speaker recognition score being greater than the second speaker recognition score.

5. The speech recognition method of claim 3, wherein
the determining of the apparatus closer to the speaker comprises:
determining the apparatus closer to the speaker based on a location of the speech recognition apparatus, a location of the other speech recognition apparatus, and previously stored information with respect to a change in a speaker recognition score based on a distance between the speaker and the speech recognition apparatus.

6. The speech recognition method of claim 1, further comprising:
outputting an impulse signal to outside of the speech recognition apparatus;
obtaining information about an external environment of the speech recognition apparatus by analyzing an audio signal received in response to the impulse signal; and
renewing previously stored information in relation to the speech signal of the registration speaker based on the information about the external environment.

7. The speech recognition method of claim 3, wherein
the determining of the apparatus closer to the speaker comprises:
determining the apparatus closer to the speaker based on previously stored speaker/distance information, the first speaker recognition score, and the second speaker recognition score with respect to a change of the speaker recognition score based on a distance between the speaker and the speech recognition apparatus,
the method further comprising: renewing the speaker/distance information based on a result of determining the apparatus closer to the speaker based on the first speaker recognition score being equal to or greater than a threshold.

8. The speech recognition method of claim 3, wherein
the determining of the apparatus closer to the speaker comprises:
predicting a distance between the speaker and the speech recognition apparatus based on previously stored speaker/distance information, the first speaker recognition score, and the second speaker recognition score with respect to a change of the speaker recognition score based on a distance between the speaker and the speech recognition apparatus; and
determining the apparatus closer to the speaker among the speech recognition apparatus and the other speech recognition apparatus based on the predicted distance,
the method further comprising: renewing the speaker/distance information based on the first speaker recognition score and the predicted distance.

9. The speech recognition method of claim 1, wherein
the obtaining of the first speaker recognition score comprises:
obtaining a plurality of candidate speaker recognition scores indicating similarities between the speech signal and speech signals of a plurality of registration speakers;
selecting a first registration speaker corresponding to a first candidate speaker recognition score having a highest value among the plurality of candidate speaker recognition scores; and.
obtaining the first candidate speaker recognition score as the first speaker recognition score based on the first candidate speaker recognition score being equal to or greater than a threshold.

10. A speech recognition apparatus among a plurality of speech recognition apparatuses located in a same space,
the speech recognition apparatus comprising:
a receiver configured to receive an input audio signal;
a processor configured to control the speech recognition apparatus to: extract a speech signal of a speaker from the input audio signal and obtain a first speaker recognition score indicating a similarity between the speech signal and a speech signal of a registration speaker; and
an outputter comprising output circuitry configured to output a speech recognition result with respect to the speech signal,
wherein the processor is further configured to
control the outputter to output the speech recognition result with respect to the speech signal based on a second speaker recognition score obtained from another speech recognition apparatus among the plurality of speech recognition apparatuses and on the first speaker recognition score.

11. The speech recognition apparatus of claim 10,
wherein the processor is further configured to control the speech recognition apparatus to:
determine an apparatus closer to the speaker from among the speech recognition apparatus and the other speech recognition apparatus based on a result of comparing the first speaker recognition score with the second speaker recognition score, and output the speech recognition result with respect to the speech signal based on the apparatus closer to the speaker being determined as the speech recognition apparatus.

12. The speech recognition apparatus of claim 11,
wherein the processor is further configured to control the speech recognition apparatus to:
determine the apparatus closer to the speaker based on a location of the speech recognition apparatus, a location of the other speech recognition apparatus, and previously stored information with respect to a change in a speaker recognition score based on a distance between the speaker and the speech recognition apparatus.

13. The speech recognition apparatus of claim 11,
wherein the processor is further configured to control the speech recognition apparatus to:
determine the apparatus closer to the speaker based on previously stored speaker/distance information, the first speaker recognition score, and the second speaker recognition score with respect to a change of the speaker recognition score based on a distance between the speaker and the speech recognition apparatus, and
renew the speaker/distance information based on a result of determining the apparatus closer to the speaker based on the first speaker recognition score being equal to or greater than a threshold.

14. A speech recognition method, performed by a device connected to a plurality of speech recognition apparatuses located in a same space, of performing speech recognition,
the speech recognition method comprising:
obtaining a first speaker recognition score indicating a similarity between a speech signal received by a first speech recognition apparatus and a speech signal of a registration speaker;
obtaining a second speaker recognition score indicating a similarity between a speech signal received by a second speech recognition apparatus and the speech signal of the registration speaker;
determining an apparatus closer to the speaker among the first speech recognition apparatus and the second speech recognition apparatus based on the first speaker recognition score and the second speaker recognition score; and
outputting a speech recognition result with respect to a first speech signal to the first speech recognition apparatus based on the apparatus closer to the speaker being determined as the first speech recognition apparatus.

15. The speech recognition method of claim 14,
wherein the determining of the apparatus closer to the speaker comprises:
determining the apparatus closer to the speaker based on a location of the first speech recognition apparatus, a location of the second speech recognition apparatus, and previously stored information with respect to a change in a speaker recognition score based on a distance between the speaker and a speech recognition apparatus.

16. The speech recognition method of claim 14,
wherein the determining of the apparatus closer to the speaker comprises:
determining the apparatus closer to the speaker based on previously stored speaker/distance information with respect to a change in a speaker recognition score based on a distance between the speaker and a speech recognition apparatus, the first speaker recognition score and the second speaker recognition score; and
renewing the speaker/distance information based on a predicted distance from the speaker to the first speech recognition apparatus and the first speaker recognition score based on the first speaker recognition score being equal to or greater than a threshold.

17. A device connected to a plurality of speech recognition apparatuses located in a same space,
the device comprising:
a communicator comprising communication circuitry configured to receive a speech signal from each of a first speech recognition apparatus and a second speech recognition apparatus and
a processor configured to control the device to obtain a first speaker recognition score indicating a similarity between a speech signal received by the first speech recognition apparatus and a speech signal of a registration speaker, obtain a second speaker recognition score indicating a similarity between a speech signal received by the second speech recognition apparatus and the speech signal of the registration speaker, and determine an apparatus closer to a speaker among the first speech recognition apparatus and the second speech recognition apparatus based on the first speaker recognition score and the second speaker recognition score,
wherein the processor is further configured to,
control the communicator to output a speech recognition result with respect to a first speech signal to the first speech recognition apparatus based on the apparatus closer to the speaker being determined as the first speech recognition apparatus.

18. The device of claim 17, wherein
the processor is further configured to control the device to:
determine the apparatus closer to the speaker based on a location of the first speech recognition apparatus, a location of the second speech recognition apparatus, and previously stored information with respect to a change in a speaker recognition score based on a distance between the speaker and a speech recognition apparatus.

19. The device of claim 17, wherein
the processor is further configured to control the device to:
determine the apparatus closer to the speaker based on previously stored speaker/distance information with respect to a change in a speaker recognition score based on a distance between the speaker and a speech recognition apparatus, the first speaker recognition score, and the second speaker recognition score; and
renew the speaker/distance information based on a predicted distance from the speaker to the first speech recognition apparatus and on the first speaker recognition score based on the first speaker recognition score being equal to or greater than a threshold.

20. A speech recognition system comprising:
a plurality of speech recognition apparatuses located in a same space and a device connected to the plurality of speech recognition apparatuses,
wherein, among the plurality of speech recognition apparatuses, a first speech recognition apparatus is configured to:
receive a first speech signal with respect to an utterance of a speaker and transmit the first speech signal to the device,
wherein, among the plurality of speech recognition apparatuses, a second speech recognition apparatus is configured to:
receive a second speech signal with respect to the same utterance of the speaker and transmit the second speech signal to the device, and
wherein the device is configured to:
obtain a first speaker recognition score indicating a similarity between the first speech signal and a speech signal of a registration speaker, obtain a second speaker recognition score indicating a similarity between the second speech signal and the speech signal of the registration speaker, determine an apparatus closer to the speaker among the first speech recognition apparatus and the second speech recognition apparatus based on the first speaker recognition score and the second speaker recognition score, and output a speech recognition result with respect to a first speech signal to the first speech recognition apparatus based on the apparatus closer to the speaker being determined as the first speech recognition apparatus.
